(19) United States
(12) Patent Application Publication
(10) Pub. No.: US 2003/0187964 A1
(43) Pub. Date: Oct. 2, 2003

(54) Method and system for updating data on an information appliance based on changes in local and remote data sources

(75) Inventors: Meurig Sage, Glasgow (GB); Philip D. Gray, Glasgow (GB)

Correspondence Address: Jefferson Perkins, Piper Marbury Rudnick & Wolfe, P.O. Box 64807, Chicago, IL, 60440-0807, US

(73) Assignee: The University Court of the University of Glasgow

(21) Appl. No.: 10/002,897

(22) Filed: Oct. 31, 2001

(51) Int. Cl. G06F 15/177

(52) U.S. Cl. 709/221; 709/224

(57) ABSTRACT

A method and system for updating data on an information appliance based on changes in local and remote data sources. The information appliance contains a set of rules These rules allow it to define links between its existing data and local and remote data sources. Using these links it can automatically gather data from these sources using context sensitive queries that are directly relevant to the current state of the information appliance. These updates can modify any data items within the system. These updates can either directly alter these data items or modify metadata about the data items, such as the set of possible values for the item. They can do this implicitly and immediately, or explicitly after the user reviews a summary of the new data and chooses to add the information using a single action. The links themselves are data items within the system. These links are defined using a structured representation and so can themselves be sent around the network. The application can therefore use the same mechanism to ask for both basis data and link specifications which can be used to gather further data. Embodiments of the invention are described.

The present invention relates to a computer method and system for automatically gathering data from local and remote computer based data sources and using the data gathered to update an information appliance, such as a PDA or laptop computer.

### BACKGROUND OF INVENTION

Information applications running on portable client devices, such as PDAs (personal digital assistants) are becoming increasingly common. Users enter and review data and expect to be able to collect data from a range of sources. These sources may include programs accessible across a computer network, sensors such as location-detectors on the client device, and changes in the state of the local application data. For instance, users may receive messages by email and then copy and paste the new data into an application. Though this can be useful, it can be cumbersome to incorporate such data into an application. Users must also explicitly search for and request the data that they require. Even when applications can download data, they tend to be restricted to a fixed set number of sources. Adding new sources and placing dependencies between these sources and data in the application is typically not possible.

These restrictions occur because the modelling and implementation of change-sensitivity is generally ad hoc. Attention has been given to the forms of change that are usefully exploited, to the methods of storage and communication of such changes in distributed systems, but little attention to the general mechanisms for mediating application-oriented links between change in source data and its desired consequential effect.

In the domain of user interface software, constraint-based mechanisms have been used for at least twenty years, although in their early incarnations the constraints were not always instantiated as links. Smalltalk's MVC (Reference 12:G Krasner and S Pope, A cookbook for using the model-view-controller user interface paradigm in Smalltalk-80. Journal of Object Oriented Programming, 1988. 1(3):p26-49) provides a notify/update mechanism for creating constraints between view and model components. However, the mechanism is not intended to be visible; it implements constraints as implicit links. It is possible, but not necessary, to create specialised model components that interpose between the source data and the dependent view. Such models can be viewed as dynamic links. Other approaches have made the links explicit and hence configurable (Reference 6: R. D. Hill, “The Abstraction-Link-View Paradigm: Using Constraints to Connect User Interfaces to Applications,” Proc. CHI '92, 1992.

The Iconographer and Representer systems treat the link as a central configurable element, with special visual programming tools for the configuration (References 4. P. D. Gray and S. Draper. A Unified Concept of Style and its Place in User Interface Design. Proc HCI '96. Springer-Verlag. pp. 49 -62; 5. P. D. Gray, “Correspondence between specification and run-time architecture in a design support tool,” in Bulding Interactive Systems: Architectures and Tools, P. D. Gray and R. Took, Eds.: Springer-Verlag, 1992, pp. 133-150. Little recent work has revisited this issue and we are now confronted with user interface components with complex interactive structures with only poorly configurable interfaces between linked components.

Similarly, dynamic links in hypermedia systems offer the potential to make the usually fixed document associations dynamically configurable, so that they reflect different potential views onto the document or so that they can change to accommodate changes in the remote resources to which the links can point (Reference 3. L. A. Carr, D. DeRoure, W. Hall and G. Hill. The Distributed Link Service: A Tool or Publishers, Authors and Readers. Proc. 4th International World Wide Web Conference. Pp. 647-656). However, these mechanisms are not generalised over other forms of data representation (e.g., representations that are not hypermedia).

Modern distributed systems architectures provide mechanisms for the implementation of distributed link structures (i.e., those in which source or destination of the link resides in a remote environment). For example, Elvin (Reference 8. Bill Segall, David Arnold, Julian Boot, Michael Henderson and Ted Phelps, Content Based Routing with Elvin4, (To appear) Proceedings AUUG2K, Canberra, Australia, June 2000) and JMS (Reference 10. Sun Microsystems, Java Messaging Service Specification, http://java.sun.com) offer facilities for establishing subscription-based notifications and data delivery from remote servers. However, while this supplies enabling technology for the link, it is not sufficient to create the link itself, which often requires access to application-oriented data and operations.

One good example of such an information appliance is a clinical system for use by anaesthetists in a hospital. Such an information application could run on a small handheld computer to allow anaesthetists to access and enter data on the move. Such systems have a number of input problems. For instance, data entry is often slow and cumbersome. In general the aim is therefore to enable users to select data rather than enter it. In many cases, the set of user-selectable options is very large (multiple thousands of options) and effective interaction requires the system to be able to present to the user a smaller subset of likely and sensible options.

An object of the present invention is to obviate or mitigate at least one of the disadvantages associated with existing computer systems, programs and methods for automatically gathering data from local and remote computer-based data sources and using the gathered data to update an information application.

### SUMMARY OF INVENTION

The present invention provides a method, system and a computer program for updating data on a client information appliance based on changes in local and remote data sources. The client information management application maintains a set of rules embodied in a computer program. These allow it to define links between its existing data and local and remote data sources. It uses these links to automatically gather data from these sources using context sensitive queries that are directly relevant to the current state of the information appliance. These updates can modify any data items within the system. These updates can either directly alter these data items, or modify meta-data about the data items such as the set of possible values for the item. They can do this implicitly and immediately, or explicitly after the user reviews a summary of the new data and chooses to add the information using a single action. The links themselves are data items with the system. These links are defined using structured text and so can themselves be sent around the network. The application can therefore use the same mechanism to ask for both basic data and link specifications which can be used to gather further data.

These and other aspects of the invention will become apparent from the following description when taken in combination with the accompanying drawings in which:

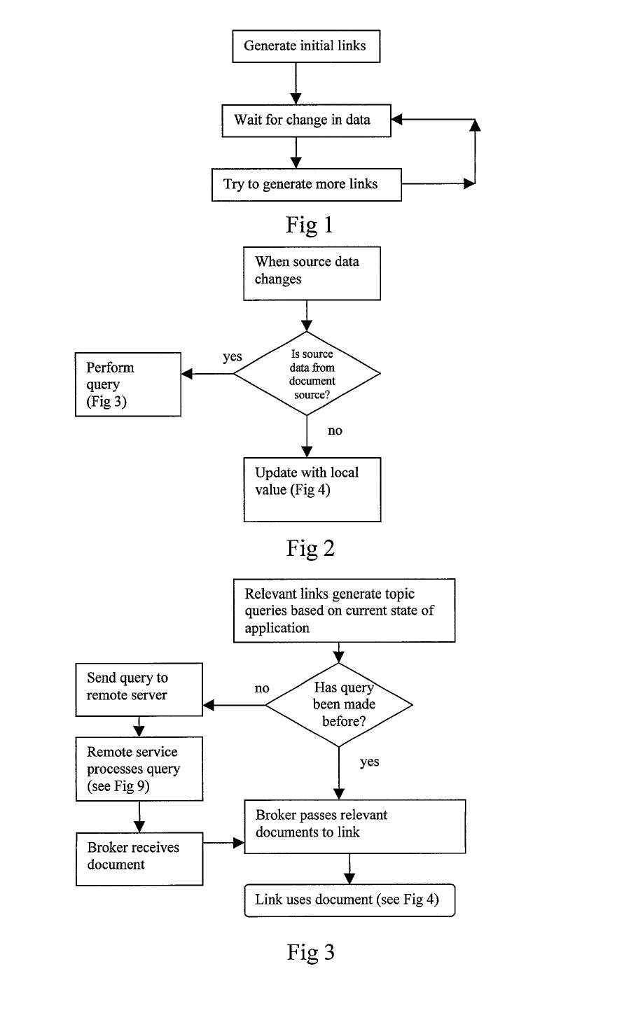

FIG. 1 is a flow chart showing a concept view of link creation;

FIG. 2 is a flow chart showing overall conceptional behaviour of an active link;

FIG. 3 is a flow chart showing conceptional behaviour of a link when generating and handling queries;

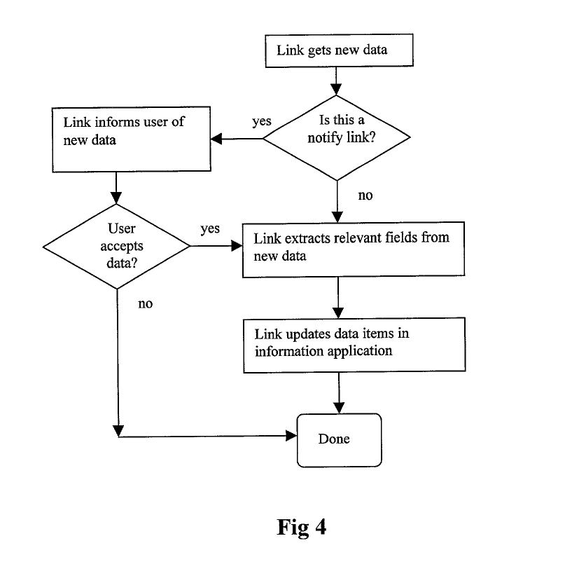

FIG. 4 is a flow chart conceptional view showing link operation behaviour;

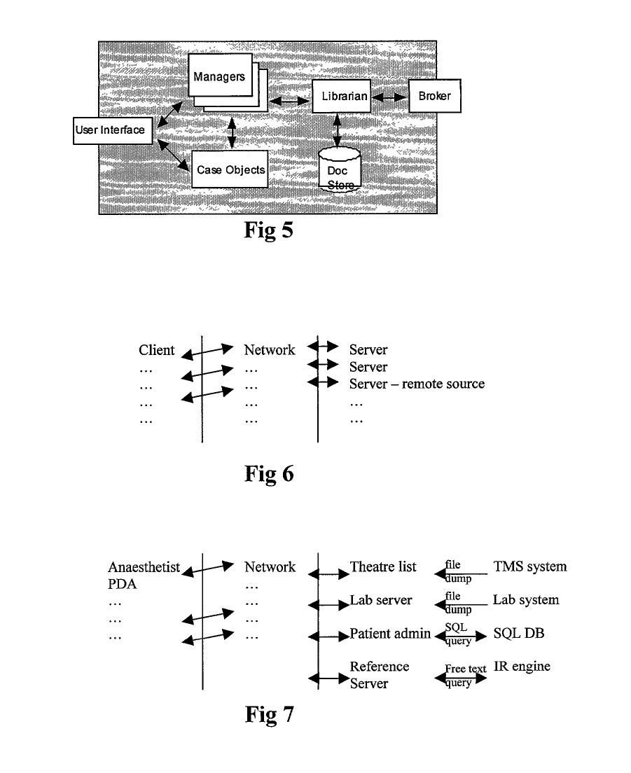

FIG. 5 is a schematic layout of the software architecture of client device in accordance with an embodiment of the invention;

FIG. 6 is a schematic representation of generic distributed architecture in accordance of an embodiment of the invention;

FIG. 7 depicts a schematic representation of an example instantiation of distributed architecture in accordance with an embodiment of the present invention;

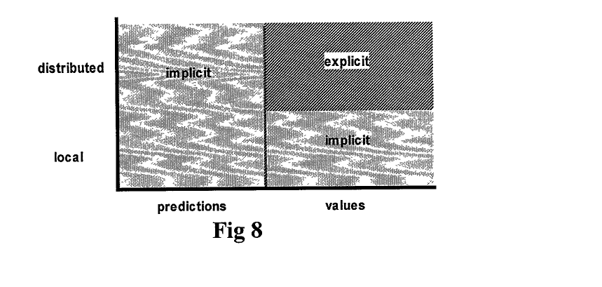

FIG. 8 is a diagram depicting dimensions of change sensitivity of client;

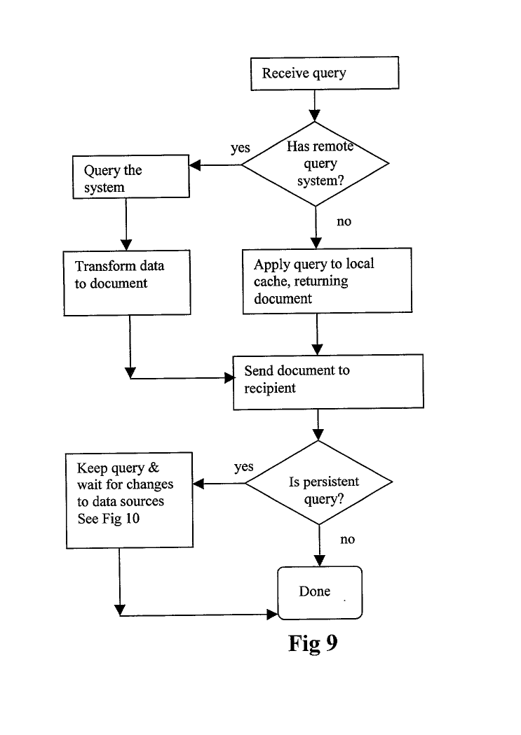

FIG. 9 is a flow chart conceptional view showing behaviour of server in response to new query;

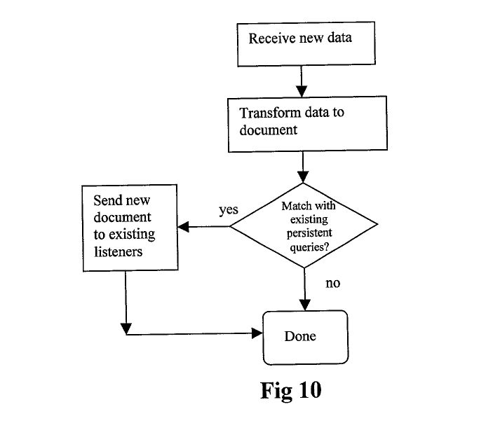

FIG. 10 is a flow chart showing behaviour of server in response to data update;

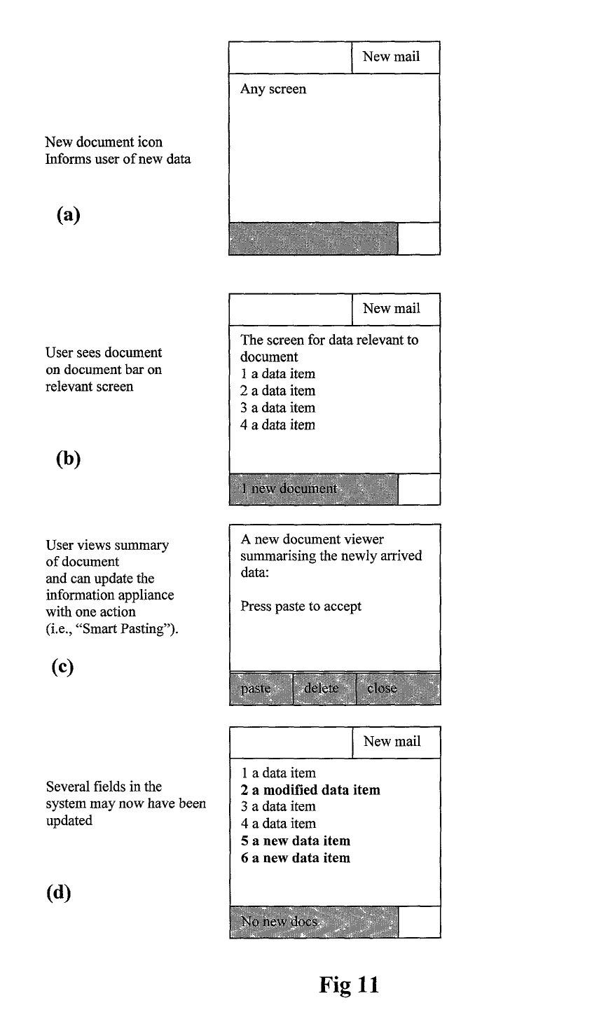

FIGS. 11a-d illustrate screen layouts for single action “Smart Pasting” on client, from user's point of view.

### DETAILED DESCRIPTION OF INVENTION

The present invention provides a method, system and computer program for applying dynamic links to interactive systems, particularly those in which client services are mediated via small, mobile context-aware devices such as PDAs and wearable devices. In this field, links can serve a number of roles, particularly relating local data items to: other local data items; data from remote services, and data from external sensors. By generalising over these different forms of link it is possible to hide from the link ends the nature of the link, improving reusability via information hiding and to centralise relevant domain knowledge for use across different link sources and destinations.

The present invention handles two sorts of links: those that maintain consistency between different elements of the local data; and those that import data from remote sources. One of the fundamental features of the present invention is that it unifies the link framework, to cope with change-sensitivity in a principled way. Therefore all links are viewed as associations that relate a source object to a destination object with respect to an aspect, or operation, via a link function:

link = <source, destination, operation,
link_function>

A link goes from a given source to a given destination, applying some form of link function to transform the data from the source, and then performs some operation on that destination. For instance, in the example medical application, a link could relate a hospital lab report on recent blood test results to the blood test results set for a particular patient, extracting all blood results from the report and transforming them into blood test data items, before adding the items to the blood test results collection for the patient.

It is occasionally useful to have multiple sources and frequently useful to have multiple destinations. For example, for a medical information appliance, a pre-operative examination document (a link source) might have information relevant to patient medical history, current medications and other clinical issues, each a separate link destination. A link is therefore a set of sources, and a set of tuples of destination, operation and function.

Link effects may vary according to the aspect of the target data that is affected. Thus, the linked source may cause a change in the value of the target (the most common relationship). However, it might also cause a change in the likelihood of certain values being appropriate.

It is also possible to distinguish between ways in which link updates take place. The link may actually cause a change to the value of the destination object or simply notify the destination that an appropriate change has taken place in the link source and let the destination object take appropriate action.

Actual link behaviour is also variable. In some cases, the link is governed by a set of constraints, as in the case of constraints among graphical elements or between multiple views onto the same data. In other cases, complex domain knowledge may be needed to resolve the link relationship. Some links cannot be resolved without the involvement of a human agent, resulting in user-assisted links. Finally, some links depend on contextual information for their resolution; that is, they behave differently depending upon the context in which they are resolved.

There are therefore three dimensions of change that must be considered: predictions vs values, distributed vs local data, and implicit vs explicit update which are shown in FIG. 8. In general, it is useful to handle prediction updates implicitly. The user does not want or need to be informed every time the system changes its set of predictions. They need to find out when they attempt to set a value on which a prediction is based. It is also useful to highlight a field if a prediction changes such that the system believes the new value is not valid. The system can do this in a visible manner without interfering with the current activity of the user. In general, it is useful to handle value updates explicitly so that the user knows what is in their system. For instance, in the medical example application, when a set of blood results arrives the anaesthetist will look at them. The anaesthetic report acts both as an aide-memoire and a legal record. It would therefore be very unhelpful if there were data in the record that the anaesthetist had not explicitly looked at and affirmed as true. Also there is a need to examine where data came from (to see what caused a value update). There can, however, be times when value updates should be implicit; for instance the calculation of “body mass index”. These implicit updates generally depend on local data changes. It is important to note that these local changes may have been propagated by updates originating in an initial remote source. For instance, the height and weight could come from a document; once those values have been updated, the body mass index will be calculated.

Reference is now made to FIG. 1 which depicts an initial set of links is created upon system startup, based on a set of link specifications; additional links may be created as the state of the application changes. Referring to FIG. 2, an instantiated link is related to its source data differently depending upon the nature of the source: if the source is purely local, the link gathers the set of new local values; if the source is remote, then it may have to communicate with that remote component, perhaps via middleware, to create a communication channel for transfer of data (see FIGS. 2 & 3). Regardless of the nature of the source type (local or remote), upon receiving new data, a link applies an update to the destination data based on the new value of the source data (see FIG. 4).

This high-level conceptual view of links shown in FIGS. 1 to 4 offers potential advantages in the flexibility of software structures to support them.

There are two basic forms of context- and change-sensitivity that the present invention can handle:

changes to local data on the information appliance

changes to the accessibility of relevant data from remote servers (i.e., the generation of requests to such servers and the subsequent arrival of responses to these requests).

FIG. 5 shows the relationship between the components on a client information appliance. There are four parts: a set of interactors (user interface), a set of resource managers (associated with some data), a library of documents and a communications subsystem (a broker). The interactors are used to communicate with users and the broker mediates communication with other remote Services.

Many links depend on domain-related data, e.g. in the example medical application the link between a surgeon's specialty and the surgical procedure for a given case. Such information is held and/or mediated via resource managers. Each manager is responsible for supplying domain-related information to the system as a whole and also for creating links associated with its domain.

Resource managers may record history about a given topic. They can also preload and provide access to lists of data. For instance, a manager responsible for current employees could preload the list of employees at start up. This list could then later be updated by data from a remote service. Because links depend on potentially variable relationships and because they must be created at run-time, the present invention includes a link specification as an explicit element in the architecture. A link specification is an object that holds the information necessary to create a link of a specified type, defined in terms of the types of its arguments.

linkspec = <source_type,
destination_type,

operation_type,
function_type>

To enable configurability, link specifications are written in a structured representation. One embodiment of this is as structured text in XML. They can therefore be stored in documents and transferred around a network. New links types can be added without the need for recoding. They can, in fact, even be added while the system is running, thus enabling dynamic reconfigurability. For instance, if a new document type were to be added in a hospital, an update could be sent out to allow all client information appliances to interpret it, without any need to disrupt the users of the system.

Link Sources

There are two sorts of link source: document and value sources. It is important to note that these sources are not simple documents or values but sources that will provide new documents or values over the duration of program execution.

In the present invention, information is transmitted between services as documents. A document in this sense is a structured collection of data, binary or textual, capable of being stored or communicated via a network. These documents may contain information relevant to a number of local links. This information must be extracted from incoming documents arriving from servers in order to resolve the links dependent on that document. A server is any system capable of responding to queries with documents, (case 1) queryable objects such as SQL-oriented databases, freetext information retrieval engines, or (case 2) information systems with proprietary data structures and interfaces if capable of generating textual reports. An example instantiation is shown in FIGS. 6 and 7.

FIG. 9 is a flow-chart that describes the behaviour of a server in response to a query. When a server receives a query it responds in one of two ways. If the server is connected to a queryable object (case 1 above), such as a database or freetext repository, it performs a query and returns an appropriately formatted document based on the query result. For instance a database SQL query might return an XML representation of the query results. Otherwise (case 2 above), the server queries its own local cache of reports generated by a legacy system, again returning a document. It then sends the document to the awaiting client. If the query is identified as persistent, the server must store the query.

FIG. 10 is a flow-chart that specifies the behaviour of a server with regard to its persistent queries. It must re-execute each persistent query on any relevant change to its queryable object or cache. This might be done whenever the server is informed that its data source has been modified. Alternatively, it might be done periodically by polling the source, for instance, by requerying the database.

FIG. 3 is a flow-chart that specifies the behaviour of a link when generating a query and responding to its results. Managers talk to brokers (through the librarian) in order to request documents. These requests are made through the following interface. A manager generates a topic that specifies the service to go to for relevant data and the query to use to extract the data. For instance, it may specify an SQL query to extract data from a database service.

The manager provides a document listener that is used to consume relevant documents. The document listener interface contains a method that receives a document and passes it to the link for processing. The document is also stored in the document library until released by the consumer. Stored documents form a local cache that can be checked for relevant documents, potentially removing the need to send a query to a remote server.

To use a source it is necessary to generate a specific request relevant to a given service. In one embodiment, this can be done by specifying a document source in XML in two parts: a from attribute specifying the service source and a request attribute specifying the query to be made of the remote service. For instance, the following source specification queries a LabResults service for all blood results for a given patient.

<PgDocSource

from=“LabResults”

request=“select BloodResults

where
subject={/case/pgSubject/hospitalNumber}”/>

The service source is the address of the server to which the request must be made. The client broker must be able to use this address to communicate with the appropriate server. For instance, distributed messaging systems such as the Java Messaging Service allow distributed communication between objects with String names. In this case, the client broker would send the request to the server and also provide its own unique name with the request to allow the server to respond. Many other distributed communication systems exist and their use here will be apparent to those skilled in the art.

Note that the above example highlights two important aspects of link specifications. Firstly, they use a simple path-based syntax for referring to the elements that make up the link, including documents and the attributes of local values (further details of both context paths and document descriptors will be given below). Secondly, the specification can refer to current data within the system, i.e., references that will be resolved at run-time. The example above specifies the hospital number of the patient in the current case.

Value Sources

The other link source type is a local value within the data structure on the client information appliance. For instance, in the medical example it is useful to have a link between a surgeon and her specialty.

All objects that serve as value sources on an information appliance must be active values, i.e., it is possible to listen for and react to changes in a value. The present invention distinguishes two sorts of active value: Attributes and Collections. Attributes contain simple object values to which can be added a listener to be notified of changes to the value.

Collections represent a dynamic list of items. It may not be necessary to hear about the whole change, but only be notified about incremental changes to the collection. It is therefore possible to add listeners to be notified of changes such as additions and deletions from a list.

In both cases, these listeners operate in a very similar way to document listeners. When a value changes, the link rule is activated and the appropriate update takes place. Therefore, it is possible to unify data from local and remote sources into a single update.

For local value sources to be supported there must therefore be program hooks to allow listeners to be added to values. This sort of support is provided by many programming systems. For instance, Sun's Java Beans model supports such an approach. It must also be possible to access these values using a path expression as discussed later in the section on Property Queries.

Based on these two source types there are two forms of source specification: value sources specify a particular attribute; collection sources specify a collection and an action that can be performed when an item is either added to or deleted from a collection. Again note that, as with document sources, context paths are used to specify a route to a given object in the current case data structure, as shown in this example of part of a link specification:

<PgValSource from=“/case/client”/>
<PgCollSource op=“add”
from=“/case/regularMedication”/>

It is sometimes useful for a link to have multiple sources. For instance, the “body mass index” calculation depends on two sources: the height and weight attributes.

Link Operations

In order to modify destination data items based on changed sources, a link must perform certain operations. FIG. 4 is a flow-chart describing the behaviour of a link when performing an operation. There are two general types of operation:

updates—operations which explicitly update some data structure,

notifications—operations which notify a data structure about a set of updates.

The simplest of the two forms of operation is update: an operation can explicitly update some data. For instance, when the value of the surgeon data item changes, the specialty data item is updated, by setting its value. There is a distinction between collection and attribute destinations. An attribute destination can be set with a given value. In contrast, an operation on a collection destination can (i) reset the entire collection or (ii) add to or (iii) delete from the collection.

One embodiment of the process followed by notification updates is illustrated from the user's point of view in the screen layouts shown in FIGS. 11a, b, c, and d. An operation can notify some destination object about a set of changes (FIG. 11a). A user can receive a notification about a new document which they may perhaps wish to add to their local data.

The user has the opportunity to review the document, and decide whether it is indeed accurate and relevant (FIG. 11c). The user can then either accept the contents and paste them into their information appliance or reject them (FIG. 11c), thereby deleting the document. Acceptance results in update operations happening which will alter the data on the client device and will normally result in an updated screen (FIG. 11d). Each of these steps can be taken using a single action. This is called “Smart Pasting”.

This form of activity is supported by a notification operation. A notification operation contains a summary function that specifies how to summarise the document (used for the review and paste process discussed above) and a set of sub-operations that specify what to do if the notification is accepted or rejected. Each of these sub-operations will extract some data from the source. A summary can be generated based on these extracted elements. For instance, the following operation specification includes a summary message for the user and an operation to be performed if the user agrees. The operation in this case adds a new element for each blood investigation to the system.

<PgNotify to=...

summary=“Blood Results {/PgBloods/@datimPublished}”>

<PgOp op=“add” mode=“collection”

to=“/case/bloodInvestigations”>

...

</PgOp>

</PgNotify>

Note that the summary in the specification above is formed from a combination of static text and data extractions. Here the source is an XML document so the extraction rule can be an XML query. In contrast, if the source were a local value then the query would be a context path query.

The notification operation generates an event that is sent to the destination. This event provides a summary, and two methods accept and reject. The summary method provides a title summary (which can, for instance, be viewed in the relevant document list) and a list of child summaries that summarise the data that is extracted from the source for each child operation. The accept method accepts all the notification. If some of the child operations fail to work, an exception is thrown summarising all the failures. The reject method rejects the notification. If this were a notification in response to a document, it would delete the document from the library document store.

While one operation can be associated with a link function it can be helpful to have multiple operations, both for ease of specification (the source specified only once) and efficiency (a single listener does several things, eliminating some of the common work).

Link Destinations

1. Value Destinations

With a value destination the actual value is changed, such as setting the surgical specialty. As outlined in the previous section several possible operations can be performed on the destination. If the operation is a notify operation then the destination is notified. In this case it must be a notifiable object. A notifiable object is a software object which can receive a notification event and handle it appropriately. For instance, by implementing code to enable the user interaction presented in FIG. 11. Otherwise, if the destination is a collection, then there must be a collection operation, such as add or delete or reset; if an attribute the operation will simply set the value. The following is an example of a link operation specification, including its attribute data item destination.

<PgOp mode=“value” op=“set” to=“/case/specialty”>

2. Predictions

Meta-data about the value of a data item is held as a prediction object belonging to the data item. This meta-data may include information about possible values, such as: a default value; a subset of likely values, and the entire value-set.

These subsets may be represented as ranges for numeric values or as lists of possible values for standard terms.

This mechanism provides a way of offering alternatives to the user, especially where there is a large set of enumerated alternatives. A prediction object can include probability values for destination alternatives. Also, the source of the prediction can be identified where several prediction-changing links are active on a single property.

Link Functions

Link functions enable additional transformations to be performed on the data before applying the link operation. A link function takes a context object (described below) and a value and generates a new value based on this input. For reasons of efficiency, it is important that the link-function is a pure function. That is, it transforms the data without any side-effecting updates. If applied at any given time in the program to the same value it should therefore return the same result. Given these conditions link functions can be precompiled so that the difficult work is done at start-up, not each time the function is called. Examples of precompilation are given below when discussing different link functions.

The present invention supports several types of link function, based on the nature of the link. These include property queries, XML queries, maps and ranges, constructors, and predefined functions. A link function can also be a composition of these functions.

1. XML Queries

The first two forms of link function are both types of query that extract data from the argument value. There are two sorts of data that may be queried: incoming documents and local data.

An extract query is the first type of query. It contains two parts: an actual query and a result type. The result type can be either collection or value. An XML Query will generally return a set of results. However, sometimes only the first result is required. In this case a value result type is used to return only one (i.e., the first) result.

An XML Query is based on the developing XPath query standard (Reference 11. W3C, XML Specification, http://www.w3c.org). The format of a query is based on a UNIX path structure, consisting of a set of entity names separated by backslashes, e.g., “/PgBloods/PgBlood”. The query can start at the root “/” or within the current context “./”.

The current context is either the incoming document or the result of some earlier query. This happens often in Constructor link-functions, detailed below. The context parameter in the link-function argument provides access to the root document that the source provided. All query link functions for a given document source can be precompiled. To do this every query is recorded. When a document arrives it is parsed once and all relevant data is extracted from it by gathering all data for each recorded query. This is particularly useful if several link-functions extract the same data.

A query can return one of four results: an attribute or a set of attributes (e.g. return the docId attribute of PgBloods entity via /PgBloods/@docId); the character data residing under an entity (eg return the text string child of /Name/-); an entity (e.g. return the PgBloods entity and attributes via /PgBloods); or a whole document subtree (e.g., return the whole PgBloods entity, attributes and children).

The following extract function extracts all the PgBlood subtrees and returns a collection of them:

<Extract type=“collection” query=“/PgBloods/PgBlood#”>

2. Property Queries

A property query extracts a value from a local data structure. Sun's JavaBeans model (Reference 9. Sun Microsystems, Java Beans Specification, http://java.sun.com/) introduced the notion that all values in a bean have a String property name through which they can be accessed. A property query is inspired by this idea. For instance, the following property link function extracts the specialty field from its argument.

<PgProperty value=“special ty”/>

A property query is in fact a Context Path. A context path can be applied to a Context object to yield a result. A Context Path is in fact more complex than a simple field name. It does in fact have similarity to an XML Query, involving a descent path which is a set of field names separated by backslashes e.g., “./subject/age”. The descent path can begin either at the root or at the current value. For this to work the client information appliance software must provide the ability to take a context path and return an object in return. Context paths into collections require some extra handling. For instance, the location of an item in a list can be specified or a query can be applied to a collection. In the latter case such a query could specify a predicate about each object in the collection eg given a collection of blood results, find objects where the Hb field is less than 115. This could be specified as shown below:

BloodResults/{Hb<115}

3. Maps

The current invention supports functions that map from keys to values. These occur commonly in prediction links. For instance, consider the case where the procedure prediction depends on the specialty of the surgeon. This requires a map from specialty names to workers. Every time the specialty value is changed, the new value will be looked up in the map to generate a new set of likely values. The list of surgeons may come from an XML file, where each entry contains a specialty field. It is important to be able to generate the map from this file using a link function. This becomes even more important when using data items containing a number of different dependencies. For instance, with medical history there are links between issues such as asthma, drugs, findings and measurements, and sometimes operations. For instance, a coronary bypass operation implies one of a set of serious heart conditions and likely drugs.

Link functions allow maps to be generated from data files. The following items need to be specified: a file type, which provides access to the data; a root query to apply to the file and a set of from and to queries. Each of these queries is an XML Query. If the data were instead to come from a software data structure then the query could instead be a context path. The root query extracts a set of document objects. The from query then extracts the map keys from each object. The to query extracts a result value. There may be one or more from and to queries. For instance, the following link function says: “extract from the PgWorkers XML source, the Worker entities; then generate a map where the keys are the specialty values of the worker entities, and the values are lists of worker entities themselves”.

| <MapExtract | file=“PgWorkers” |
|---|---|
| | root=“PgWorkers/Worker” |
| | from=“./@specialty” |

to=“./”>

The use of pure functions is particularly important here. We can use partial lazy evaluation here. That is the link function can be precompiled, reading in the data once and then applying all following transformations to the results. Thus, when a change occurs only a simple hash-map lookup needs to be performed, an operation that is very fast-to perform. For instance, in the above case we create a map from specialties to lists of workers by parsing a data file once. Imagine that we then use a constructor function (discussed below) to turn each XML worker object into a software data item. This conversion could be done once for each XML worker result rather than every time the function is reused.

4. Ranges

The current invention supports functions that return ranges. Ranges are very similar to maps. Given a value, and a set of non-overlapping ranges it lies within, a set of likely results can be generated. For instance, if a patient's “body mass index” is greater than a given value, they are likely to be obese. This form of relationship can be specified using range link functions. The measurement entity has two important attributes minValue and maxValue. Using these a mapping from a list of measurement ranges to medical issues can be generated. Again the relevant data file would be read once to produce a range list (that is a mapping from each measurement to a list of issues). Then when a measurement value is supplied a binary search can be performed on the range list.

<MapExtract file=“PgIssues”
root=“PgIssues/Issue”
from=“./Measurement”
to=“./”
op=“range”>

5. Constructors

A Constructor object converts the extracted data into a data item on the client application, taking as parameters the target data item's code name and additional parameters as necessary. These additional parameters specify Extract queries. For instance, given an XML source document these will be XML Extract queries. Each of these queries generates one parameter. These queries may have children, i.e., there may be a query that extracts a collection of values, and applies a further constructor to that result.

For instance, consider the following constructor. It generates a blood investigation data item. It extracts the date attribute as its first parameter and then generates a collection of blood results, one for each result value for its second parameter.

<PgConstructor
ref=“PgInvestigationBlood”>
<Extract type=“value” query=“./@date” />

<Extract type=“collection”

query=“./Result/@value” >

<PgConstructor

ref=“PgInvestigationBloodResult”/>

</Extract>

</PgConstructor>

This requires a program hook that generates a data item based on the name and parameters. One embodiment of this could use reflection as provided by programming languages such as Java.

6. Predefined Functions

The current invention supports pre-defined functions, because sometimes the set of functions defined above is not enough. In this case pre-programmed link functions can be called. This is most common for arithmetic calculations. For instance, to calculate the age of an individual based on their date of birth, a function must be defined in the information appliance's host language.

<PgPredefined value=“calcAge”/>

Although the present invention has been described in terms of various embodiments, it is not intended that the invention be limited to these embodiments. Modification within the spirit of the invention will be apparent to those skilled in the art. In particular: (i) the method of interaction with the user during notification may involve means other than textual display and user input via a keyboard and mouse; for example, user notification during “Smart Pasting” might be presented via synthesised speech and user input via voice or production of a non-speech sound; (ii) the method of representation of documents and queries need not use XML, but may employ other forms of structure-encoding including a serialised binary representation; (iii) though one embodiment of link specifications may use XML, this is not the only possible representation; links may be described using a textual language or they may be represented via dynamically loadable code; (iv) the information held in an attribute prediction need not be a list of nominated values, but might include information for knowledge-based decision support, (v) the clients and servers may communicate over any data network.

The following scenarios illustrate examples of data gathering and updating supported on an information appliance by the invention:

1. When a document, such as a set of blood results, arrives, a title summary is presented on the information appliance display. The anaesthetist can open the document in a reader panel and view its contents. They can then choose to paste the details into their current anaesthetic record, or to delete it if not relevant.

2. Certain elements within the system are automatically generated. For instance, when the anaesthetist enters the height and weight of the patient, the system can generate the “body mass index” which is used to determine if a patient suffers from obesity.

3. Mutual dependencies exist between a great deal of the data within the system. These frequently can only be expressed as predictions rather than actual definite changes. For instance, if a patient has a given complaint such as asthma it is possible to predict that they are likely to be on one (possibly more) of a limited set of asthmatic drugs.

4. Predictions can also depend on remote data. A user could select the operating surgeon from a set of surgeons. This prediction set will change if the staff list changes and a new list is sent out. Anaesthetic plans come from remote servers; the choice of plans is affected by data on the information appliance (i.e., the patient's medical record) and on a remote server (i.e., the set of plans available in a database). Matching can take place on a remote machine and the predicted set of plans updated on the appliance.

Although the above examples provide illustrations of the use of the present invention, it is not intended that the invention be limited to this medical application embodiment. Applications involving local client data and a range of servers exist in a number of domains and the use of this approach in these will be apparent to those skilled in the art.

The tag-based data description language, XML (“The extensible Markup Language”), has become popular as a means of describing not only end-user data but also the configuration of software components that store and process such data (Reference W3C, XML Specification, http://www.w3c.org.)

XML provides a basis for describing the data involved in the gathering/updating processes described above as well as relationships among interdependent data items and the software components that manage such relationships.

It will be understood that various modifications may be made without departing from the scope of the invention. Firstly, the information appliance may be a personal digital assistant, laptop, palmtop, cellphone, electronic diary, desktop computer or any electronic appliance capable of running the software described herein. The data camera may be a CD, DVD, floppy disk tape, integrate circuit, PROM or the like, as will be apparent to a person of skill in the art. The rules may be represented in other structured data representations, such as disclosed in the following international standards: ISO 10303 Step/Express Language

ISO 8879 SGML (Standard Generalised Mark Up Language).

Other structured data representations may be used instead of XML as long as they have the same semantics as will be apparent to a person of ordinary skill in the art.

1. A computer program product for automatically gathering data from remote and local computer-based data sources and using gathered data to update an information appliance comprising computer program code recorded on a data carrier, said computer program code comprising:
code for loading a set of rules to permit said program to define a set of links between said information appliance and said remote or local source;
instantiating code for instantiating said set of rules to gather data from said remote or local data source;
communication code for permitting said information appliance to communicate with said local or remote data source, and
updating code for updating data stored in said information appliance based on data gathered from said remote or local data source.

2. A computer program product as claimed in claim 1 wherein said code for permitting said information appliance to communicate with said local or remote data carrier is provided by network code for providing a distributed communications mechanism for use with remote data sources.

3. A computer program product as claimed in claim 2 wherein said network includes a code section which is located at said remote data source.

4. A computer program product as claimed in claim 1 wherein said communicating code is provided by code for querying local data sources and listening code for detecting when data values change.

5. A computer program product as claimed in claim 1 wherein said updating code includes code means for updating collection and individual data values automatically without input from a user.

6. A computer program product as claimed in claim 1 wherein said updating code is provided by user interface code for providing a summary of gathered data to said user and user responsive code means for accepting or rejecting said data.

7. A computer program product as claimed in claim 1 including transform code for transforming data between a first format to a second format as required by a local or remote data source connected to said information appliance.

8. A computer program for automatically gathering data from remote and local data sources and using the gathered data to update an information appliance, said computer program comprising:
code for generating a set of rules to permit said program to define a set of links between said information appliance and said remote or local source;
instantiating code for instantiating said set of rules to gather data from said remote or local data source;
communication code for permitting said information appliance to communicate with said local or remote data source, and
updating code for updating data stored in said information appliance based on data gathered from said remote or local data source.

9. A system for automatically gathering data from remote and local computer-based data sources and using gathered data to update an information appliance coupled to said system, said system comprising:
at least one information appliance for use by a user for gathering data from said local or remote data sources, at least one local or remote data source electronically coupled to said information appliance, and
a computer program as claimed in claim 8 stored in at least one information appliance for:
controlling transfer of data between said information appliance and said remote or local source so that said information appliance gathers data from said remote or local data sources, and
updating data in said information appliance from said gathered data.

10. A system as claimed in claim 9 wherein the link rule specifications and data are written in XML structured textual language.

11. A system as claimed in claim 9 wherein said link rule specifications and data are computer program is implemented in a binary representation of XML.

12. An information appliance for using in a data gathering system having at least one local data source or at least one remote data source, said information appliance comprising:
communication means for permitting said information appliance to communicate with said local or remote sources;
computer program means for gathering data from said local or remote sources to said information appliance and for updating data in said information appliance with said gathered data.

13. An information appliance as claimed in claim 12 having means for permitting the appliance to run the computer program as claimed in claim 8.

14. An information appliance as claimed in claim 12 wherein said appliance includes a display for displaying data updates to a user and user control means for permitting the user to select or reject displayed updated data.

15. A method of automatically gathering data from a local or remote source by an information appliance and for using said gathered data to update the data in said information appliance, said method comprising the steps of:
coupling said information appliance electronically to said local or remote data source;
gathering data from said local or remote source by electronically transferring said data to said information appliance, and
updating said information appliance with said gathered data.

16. A method as claimed in claim 15 including the steps of displaying said updated gathered data to a user and selecting the displayed data for inclusion or rejection.

17. A method as claimed in claim 15 wherein the user selects acceptance or rejection of the data by a single action.

18. A method as claimed in claim 15 wherein the user selects acceptance or rejection of data by clicking a button or by making a sound.

19. A method as claimed in claim 16 including the step of detecting when there is a difference between a data standard in said information appliance and the data standard of said local or remote data source and transforming data from said local or remote data source to the data standard of said information appliance.
